(19) United States
(12) Patent Application Publication
(10) Pub. No.: US 2009/0238162 A1
(43) Pub. Date: Sep. 24, 2009

(54) WIRELESS BASE STATION, COMMUNICATION CONTROL METHOD AND PROGRAM STORAGE MEDIUM

(75) Inventor: Seijiro Yoneyama, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/405,407

(22) Filed: Mar. 17, 2009

(30) Foreign Application Priority Data
Mar. 24, 2008 (JP) 2008-76282

(51) Int. Cl. H04W 24/02

(52) U.S. Cl. 370/338

(57) ABSTRACT

A wireless base station according to an aspect of the present invention is one of a plurality of base stations each forming a wireless area and communicating with a mobile station within the wireless area. The wireless base station includes a reception unit configured to receive a connect request from a mobile station that exists within the wireless area; an information acquirer configured to acquire connection history information indicating connection history to a base station which was connected by the mobile station in the past; a condition storage configured to store a connection permission condition to permit connection with the mobile station; a judgment unit configured to judge whether or not the connection permission condition is satisfied based on the connection history information; and a reporting unit configured to report a message of connection permission to the mobile station when the connection permission condition is satisfied.

### CROSS REFERENCE TO RELATED APPLICATIONS

This application is based upon and claims the benefit of priority from the prior Japanese Patent Applications No. 2008-76282, filed on Mar. 24, 2008; the entire contents of which are incorporated herein by reference.

### BACKGROUND OF THE INVENTION

1. Field of the Invention

The present invention relates to a wireless base station, communication control method and a program storage medium storing a communication program for performing the communication control method.

2. Related Art

In a wireless LAN (Local Area Network) system compliant with the IEEE802.11 standard, a mobile station connects to a wireless network by specifying an identifier (SSID: Service Set Identifier) assigned to a group of a plurality of base stations. The system is designed such that the mobile station selects and determines a base station to which the mobile station is finally connected from among the base stations belonging to the SSID. For example, the scheme described in JP-A 07-87011(Kokai) that selects a base station of good reception electric field strength and the scheme described in JP-A 09-261711(Kokai) that selects a base station which is physically close to a mobile station using an interface (GPS or the like) for acquiring physical positions are schemes generally used.

However, the selection scheme using wireless propagation quality such as reception electric field strength might mistakenly select a base station of bad communication quality if wireless propagation quality drastically changes under the influences of an environment. For example, despite the fact that a system administrator conducts a careful site survey on a certain floor and installs a base station which is supposed to have good communication quality, if temporary wireless interference occurs at the moment a mobile station attempts to connect to a wireless network, the mobile station may end up being connected to a base station of bad communication quality installed on another floor.

On the other hand, the selection scheme using an interface (GPS or the like) that acquires physical locations allows connection to a base station that enables good communication quality to be stably obtained independently of variations in wireless propagation quality but involves a problem of increases in cost for introducing a new interface and cost for operation/maintenance thereof.

As described above, when a mobile station connects to a wireless network by specifying an SSID, the conventional scheme that uses wireless propagation quality has the problem of mistakenly connecting to a base station of bad communication quality. On the other hand, the scheme that selects a base station based on physical locations allows connection to an appropriate base station, but involves the problem of increasing introduction, operation and maintenance costs.

### SUMMARY OF THE INVENTION

According to an aspect of the present invention, there is provided with a wireless base station, which is one of a plurality of base stations each forming a wireless area and communicating with a mobile station within the wireless area, comprising:

a reception unit configured to receive an connection request from a mobile station that exists within the wireless area;

an information acquirer configured to acquire connection history information indicating connection history to a base station which was connected by the mobile station in the past;

a condition storage configured to store a connection permission condition to permit connection with the mobile station;

a judgment unit configured to judge whether or not the connection permission condition is satisfied based on the connection history information; and

a reporting unit configured to report a message of connection permission to the mobile station when the connection permission condition is satisfied.

### BRIEF DESCRIPTION OF THE DRAWINGS

FIG. 1 shows a configuration example of a communication system according to an embodiment of the present invention;

FIG. 2 is a block diagram schematically showing a configuration of the base station and connection history management server in FIG. 1;

FIG. 3 shows an example of connection history information of a mobile station H1;

FIG. 4 shows an example of connection history information of a mobile station H2;

FIG. 5 shows an example of connection permission conditions set in a base station B;

FIG. 6 shows an example of updated connection history information of the mobile station H1;

FIG. 7 is a flowchart showing an operation flow of a base station;

FIG. 8 shows an example of a floor configuration;

FIG. 9 is shows an example of a connection permission condition set in the base station A in the floor configuration in FIG. 8;

FIG. 10 shows an example of a connection permission condition set in the base station B in the floor configuration in FIG. 8;

FIG. 11 shows another example of floor configuration;

FIG. 12 shows an example of a connection permission condition set in the base station A in the floor configuration in FIG. 11;

FIG. 13 shows an example of a connection permission condition set in the base station B in the floor configuration in FIG. 11;

FIG. 14 shows a further example of floor configuration;

FIG. 15 shows an example of a connection permission condition set in the base station A in the floor configuration in FIG. 14;

FIG. 16 shows an example of a connection permission condition set in the base station B in the floor configuration in FIG. 14;

FIG. 17 shows an example of connection history information of the mobile station H in the floor configuration in FIG. 14;

FIG. 18 shows an example of updated connection history information of the mobile station H in the floor configuration in FIG. 14;

FIG. 19 shows an example of connection permission conditions to which an access category compliant with the IEEE802.11e standard is added;

FIG. 20 shows another configuration example of the communication system according to the embodiment of the present invention; and

FIG. 21 is a block diagram schematically showing a configuration of the base station and mobile station shown in FIG. 20.

### DETAILED DESCRIPTION OF THE INVENTION

With reference now to the attached drawings, an embodiment of the present invention will be explained below.

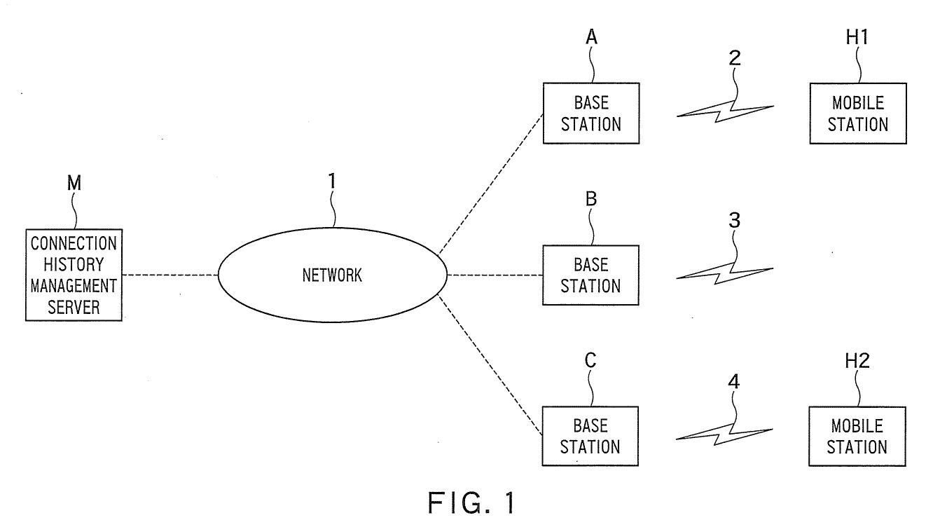

FIG. 1 shows a configuration example of a communication system according to an embodiment of the present invention.

In FIG. 1, reference numeral 1 denotes a network, reference characters A, B and C denote base stations (wireless base stations) connected to the network 1. The base stations A, B and C each form a wireless area. Reference numerals 2, 3 and 4 denote wireless links. A mobile station H1 is a mobile station connected to the wireless link 2 and located within a wireless area of the base station A. A mobile station H2 is a mobile station connected to the wireless link 4 and located within a wireless area of the base station C. An connection history management server M is connected to the network 1 and manages histories of connection to the base station by each mobile station. FIG. 1 shows an example where one mobile station is connected to one base station, but a plurality of mobile stations may also be connected to one base station.

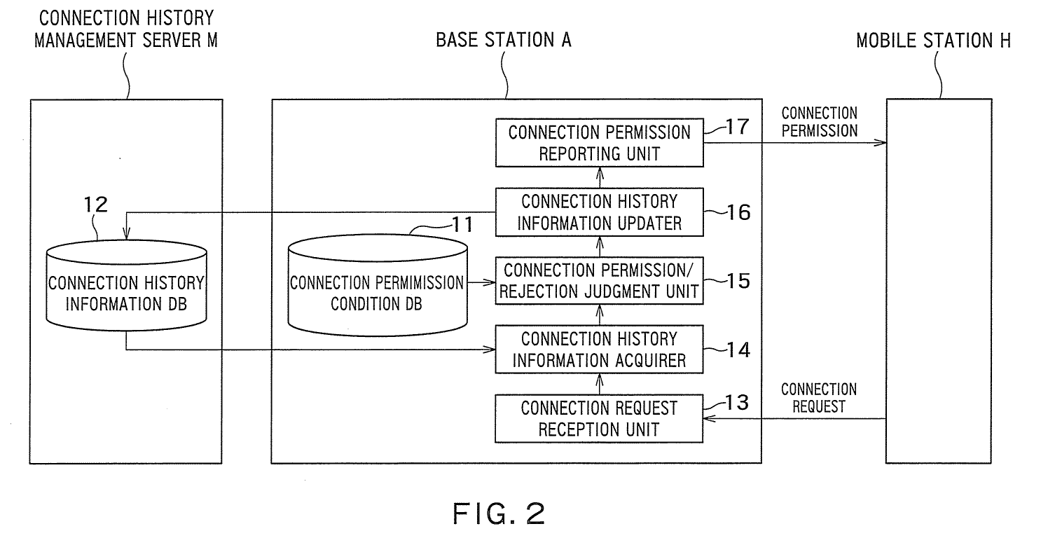

FIG. 2 shows a configuration example of the base station A and connection history management server M according to this embodiment. Here, the configuration of only the base station A out of the base stations A to C is shown, but the base stations B and C also have a configuration similar to that of the base station A.

As shown in FIG. 2, the base station A is provided with an connection permission condition database (a condition storage) 11 that manages connection permission conditions for permitting connection to the mobile station and the connection history management server M is provided with an connection history information database 12 that manages connection history information on wirelessly connected mobile stations.

The base station A is provided with a connect request reception unit (a reception unit) 13 that receives a connect request from the mobile station, an connection history information acquirer (an information acquirer) 14 that acquires connection history information on the mobile station from which the connect request reception unit 13 has received the connect request from the connection history information database 12 of the connection history management server M, an connection permission/rejection judgment unit (a judgment unit) 15 that judges connectibility for the mobile station based on whether or not the acquired connection history information satisfies connection permission conditions managed by the connection permission condition database 11, an connection history information updater (an information updater) 16 that updates the connection history information on the mobile station whose connection has been permitted and uploads the connection history information to the connection history information database 12 of the connection history management server M and an connection permission reporting unit 17 that reports permission of connection or rejection of connection to the mobile station.

An example where the respective modules 11, 12, 13, 14, 15, 16 and 17 are configured as hardware has been explained, but the present invention is not limited to this, and the base station A or connection history management server M may also be adapted so as to provide the functions as software executed on a computer. In this case, software (communication program) is stored in a storage such as a hard disk or recording medium such as CD-ROM and can be read from this storage or recording medium and executed.

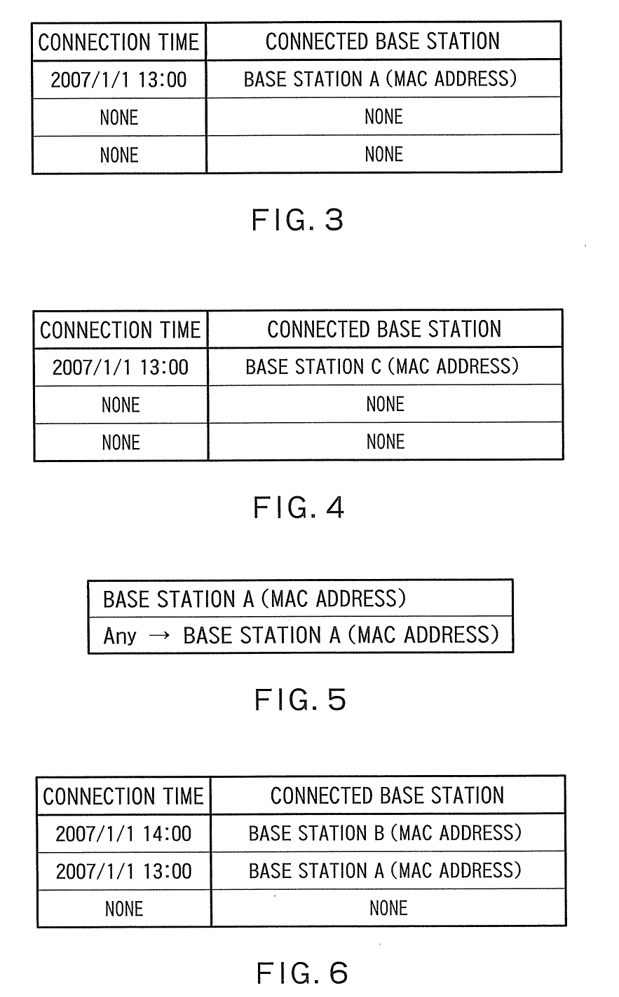

Suppose an initial state of the system is defined such that the mobile station H1 connects to the base station A for the first time (the mobile station H1 has not been connected to any base station before connecting to the base station A) and the mobile station H2 connects to the base station C for the first time. Therefore, in the initial state, the connection history information on the mobile station H1 and mobile station H2 managed by the connection history management server M is as shown in FIG. 3 and FIG. 4. The connection history information in FIG. 3 and FIG. 4 is defined as a table including connection times and MAC addresses of connected base stations. However, this merely shows an example and it is also possible to perform management based on, for example, connection order in addition to connection times and based on identifiers specific to base stations in addition to MAC addresses. Furthermore, the history storage capacity is up to three entries (three base stations) and connection order is managed in descending order.

Furthermore, as an example of the initial state of the system, suppose the connection permission condition in FIG. 5 is set in the connection permission condition database 11 of the base station B. The connection permission condition in FIG. 5 means that a connection to the base station A immediately before handoff is necessary but connection histories prior thereto are not questioned. The connection permission condition in FIG. 5 is made up of two conditions and connection is permitted if only any one of the two is met. The condition on the upper row in the figure shows that the mobile station connects to the base station A immediately before handoff and was not connected to any base station earlier, and the condition on the lower row in the figure shows that the mobile station connects to the base station A immediately before handoff and any connection was possible earlier, that is, though the mobile station needs to have been connected to at least one base station, it is not questionable to which base station the mobile station have been connected in what connection order.

Given the above described initial state, the operation of the base station B will be explained as an example.

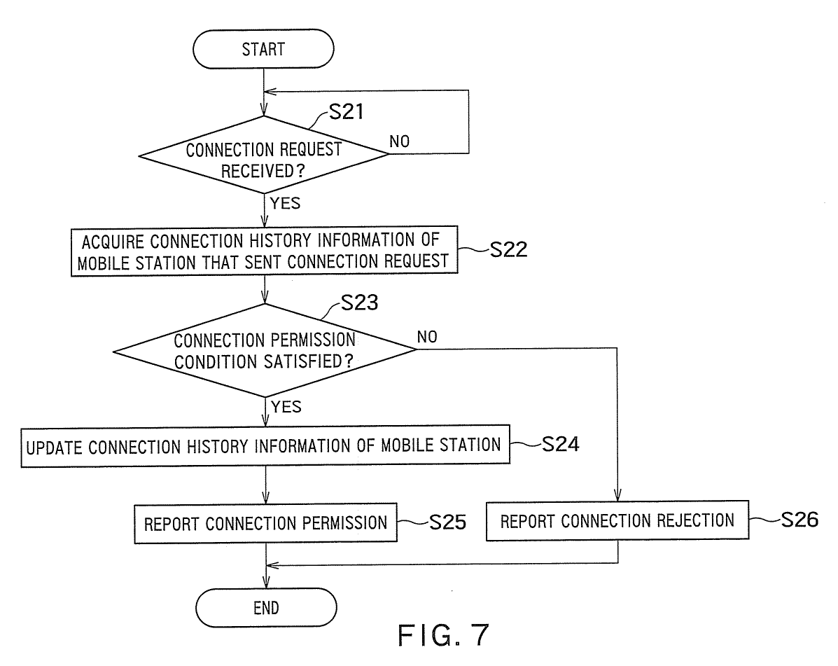

FIG. 7 is a flowchart showing the operation flow of the base station B.

First, a case where the mobile station H1 attempts to connect to the base station B will be considered.

First, the mobile station H1 sends a connect request to the base station B. The base station B receives the connect request (YES in S21) from the mobile station H1 and makes an inquiry to the connection history management server M (sends a message requesting the acquisition of connection history information) and thereby acquires the connection history information of the mobile station Hi shown in FIG. 3 (S22).

Next, the base station B refers to the connection permission condition in FIG. 5 and judges whether or not the connection history information of the mobile station Hi satisfiers this connection permission condition (S23). Since the mobile station H1 was connected to the base station A before handoff, the mobile station HI satisfies the connection permission condition, and therefore connection is judged to be permitted (YES in S23).

Next, the base station B updates the connection history information acquired for the mobile station Hi by adding the latest entry (base station B) thereto and uploads the updated connection history information to the connection history management server M (S24). That is, the base station B sends an update request message requesting an update of the connection history information of the mobile station H1 to the connection history management server M so as to include the base station B as the latest connection destination. FIG. 6 shows the updated connection history information.

Finally, connection permission is reported to the mobile station H1 (S25). In this way, the connection between the mobile station H1 and the base station B is established and handoff can be realized.

Next, consider a case where the mobile station H2 attempts to connect to the base station B.

First, the mobile station H2 sends a connect request to the base station B. Next, the base station B receives the connect request (YES in S21), makes an inquiry to the connection history management server M (sends a message requesting the acquisition of connection history information) and thereby acquires the connection history information of the mobile station H2 shown in FIG. 4 (S22).

Next, the base station B refers to the connection permission condition in FIG. 5 and judges whether or not the connection history information of the mobile station H2 satisfies the connection permission condition (S23). Since the mobile station H2 was connected to the base station C before handoff, the mobile station H2 does not satisfy the connection permission condition, and connection is therefore judged to be rejected (NO in S23). In this case, the base station B does not update the connection history information on the mobile station H2 and reports “connection rejection” to the mobile station H2 (S26).

This makes it possible to realize handoff control that does not allow the connection between the mobile station H2 and the base station B to be established.

Hereinafter, an embodiment will be shown in consideration of physical locations of living rooms or the like more specifically.

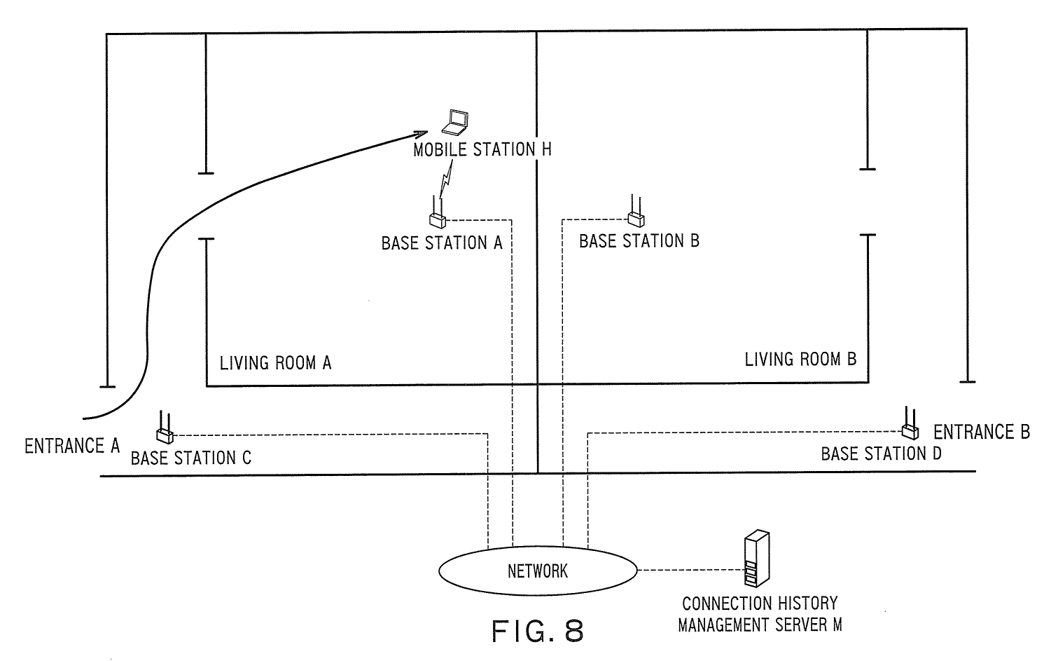

FIG. 8 shows a floor configuration that allows entry into a living room A through an entrance A and entry into a living room B through an entrance B. Base stations are installed at the respective living rooms and entrances and suppose not only a radio wave of the base station A but also a radio wave of the base station B arrives at the living room A through a wall as an obstacle. Therefore, when the mobile station H enters the living room A, the mobile station H may connect to both the base station A and the base station B, and the mobile station H acquires good communication quality when connecting to the base station A, whereas the communication quality remains at a low level when connecting to the base station B.

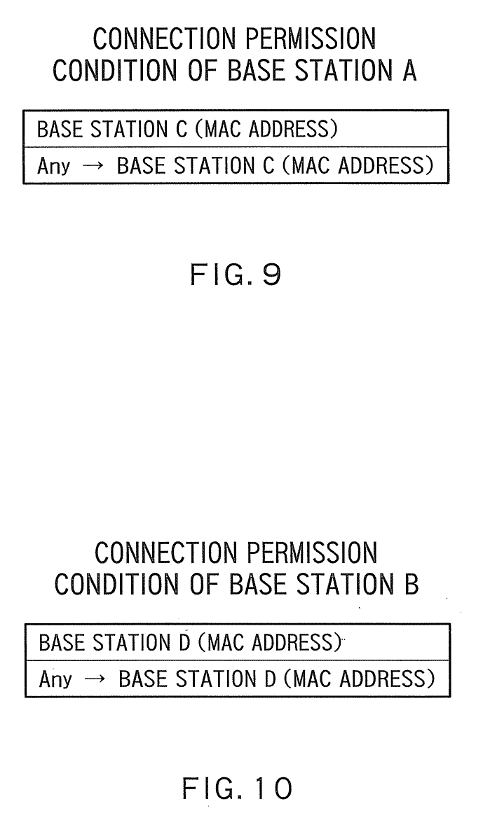

Here, the administrator sets the inclusion of the base station C as the base station immediately before handoff in the connection history information in the connection permission condition of the base station A and sets the inclusion of the base station D as the base station immediately before handoff in the connection history information in the connection permission condition of the base station B. FIG. 9 shows the connection permission condition set in the base station A and FIG. 10 shows the connection permission condition set in the base station B. On the other hand, no connection permission condition is set in the base station C and base station D. That is, suppose connection to the base station C and base station D is permitted unconditionally.

Assume a case where the mobile station H passes through the entrance A and enters the living room A. When passing through the entrance A, the mobile station H attempts to connect to the base station C. Upon receiving a connect request, the base station C acquires connection history information of the mobile station H from the connection history management server M, adds the base station C to the connection history information as the latest entry and uploads the connection history information after the addition to the connection history management server M again. Next, the mobile station H enters the living room A. In this case, the connection history information of the mobile station H satisfies the connection permission condition of the base station A (see FIG. 9), but does not satisfy the connection permission condition of the base station B (see FIG. 10). This ensures that the mobile station H can only connect to the base station A of good communication quality.

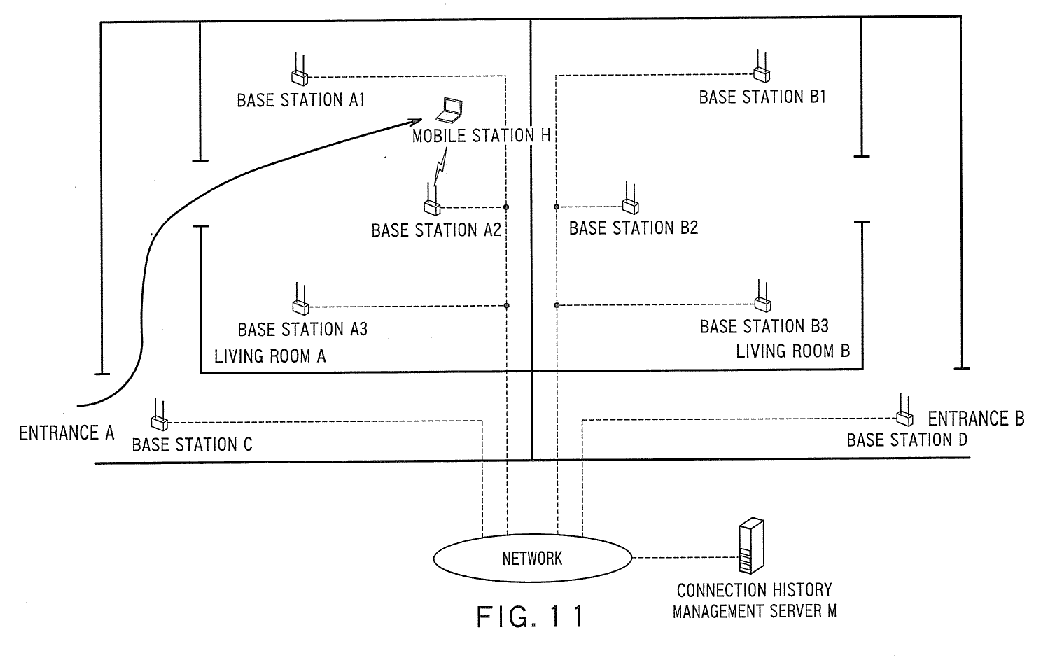

Like FIG. 8, FIG. 11 shows a floor configuration that allows entry into the living room A through the entrance A and entry into the living room B through the entrance B. A difference from FIG. 8 lies in that a plurality of base stations are installed in each living room for the purpose of distributing load. Therefore, the mobile station H in the living room A needs to permit handoff among base stations A1, A2 and A3.

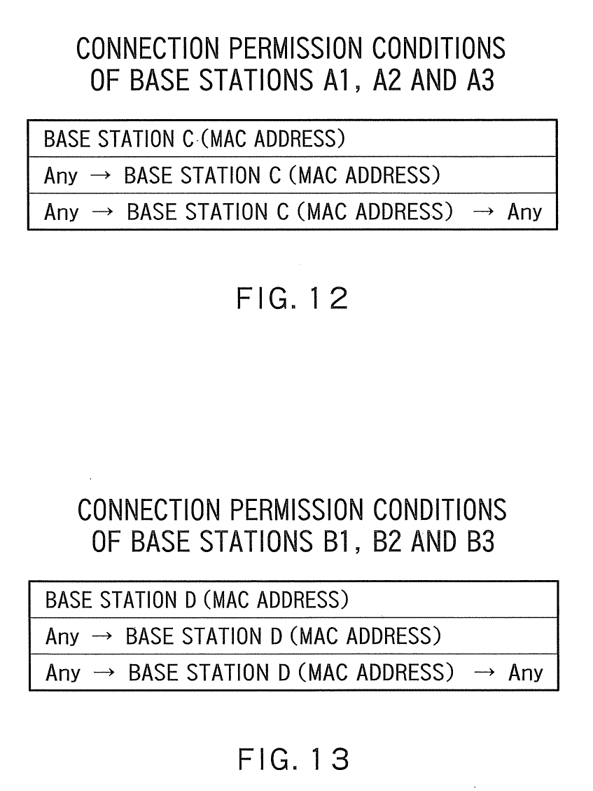

Here, the administrator sets a condition of requesting the inclusion of connection to the base station C in the connection history information as the connection permission condition of the base stations A1, A2 and A3 and sets a condition of requesting the inclusion of connection to the base station D in the connection history information as the connection permission condition of base stations B1, B2 and B3. FIG. 12 and FIG. 13 show examples of the connection permission conditions set in the base stations A1 to A3 and base stations B1 to B3.

FIG. 12 corresponds to the connection permission condition in FIG. 9 with the restriction of being connected to the base station C immediately before handoff removed. That is, this corresponds to the connection permission condition in FIG. 9 changed in such a way that connection to the base station C only needs to be included in the connection history information if not immediately before handoff.

FIG. 13 corresponds to the connection permission condition in FIG. 10 with the restriction of being connected to the base station D immediately before handoff removed. That is, this corresponds to the connection permission condition in FIG. 10 changed in such a way that connection to the base station D only needs to be included in the connection history information if not immediately before handoff.

On the other hand, no connection permission condition is set in the base station C and base station D. That is, suppose connection to the base station C and base station D is permitted unconditionally.

Assume a case where the mobile station H passes through the entrance A and enters the living room A. When passing through the entrance A, the mobile station H attempts to connect to the base station C. Upon receiving the connect request, the base station C acquires connection history information of the mobile station H from the connection history management server M, adds the base station C to the connection history information as the latest entry and uploads the connection history information after the addition to the connection history management server M again. Next, the mobile station H enters the living room A. In this case the connection history information of the mobile station H satisfies the connection permission conditions of the base stations A1, A2 and A3, but does not satisfy the connection permission conditions of the base stations B1, B2 and B3. This ensures that the mobile station H can only connect to A1, A2 and A3 of good communication quality.

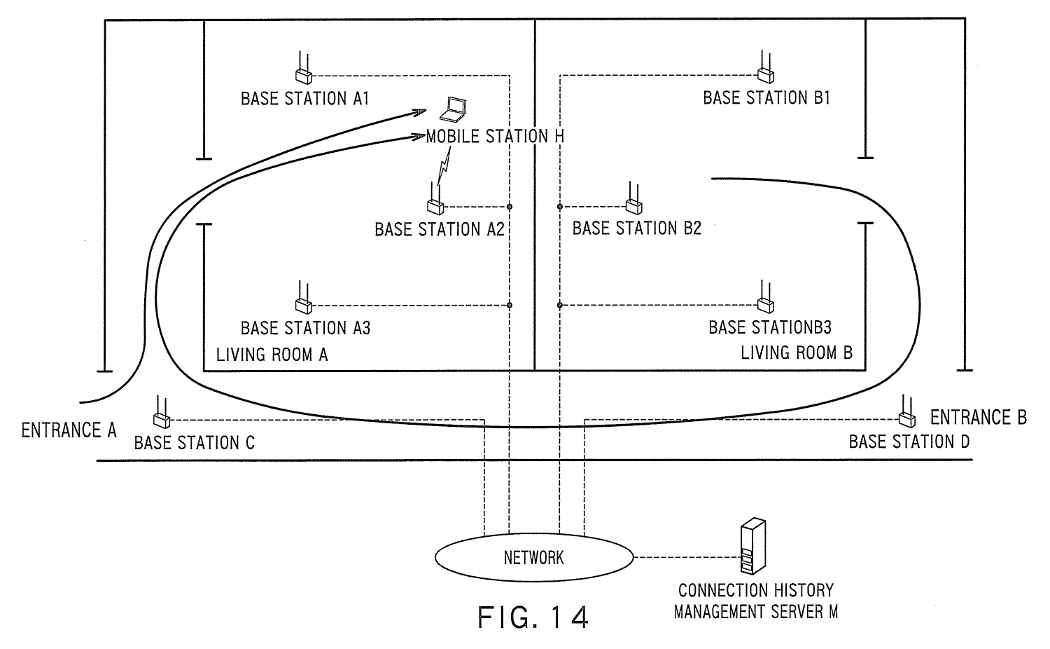

FIG. 14 is a floor configuration that allows entry into both living rooms through the respective entrances. What should be noted is that under the connection permission conditions shown in FIG. 12 and FIG. 13, when the mobile station H moves from the living room B to the living room A, the mobile station H may mistakenly connect to a base station (B1 to B3) in the other living room.

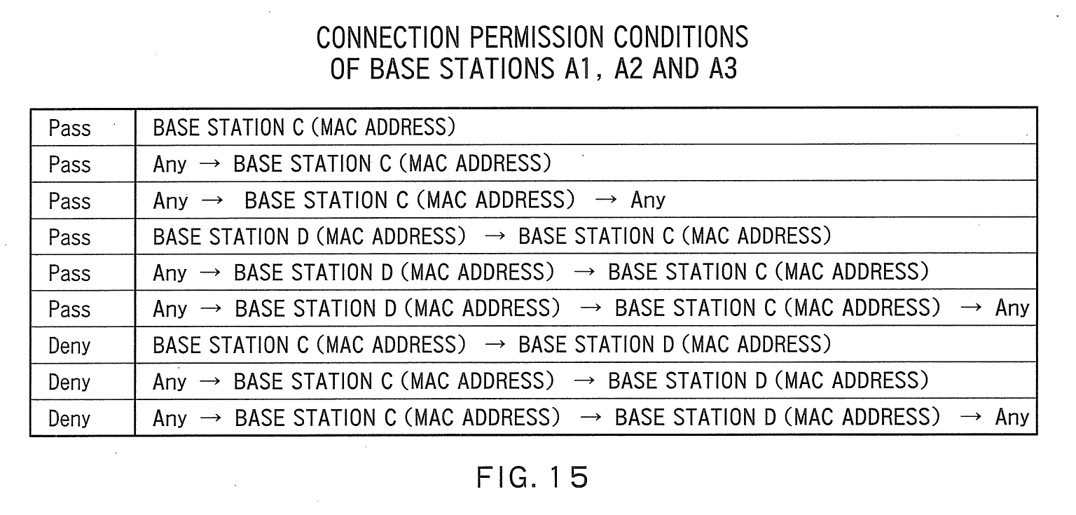

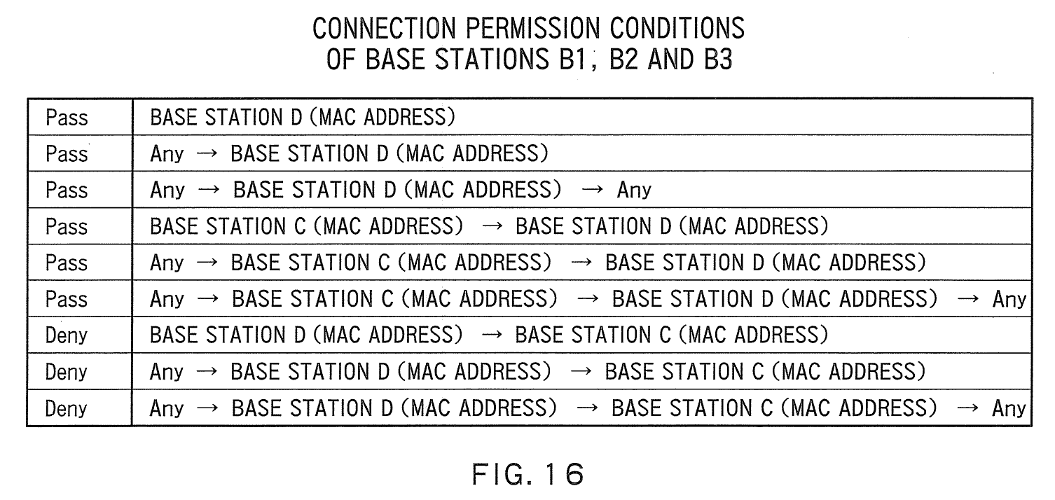

Here, the administrator further adds a condition of permitting connection when connection in the order of “base station D→base station C” is included in the connection history information and a condition of not permitting connection when connection in the order of “base station C→base station D” is included in the connection history information to the connection permission condition in FIG. 12 in the base stations A1, A2 and A3. Furthermore, the administrator further adds a condition of permitting connection when connection in the order of “base station C→base station D” is included in the connection history information and a condition of not permitting connection when connection in the order of “base station D→base station C” is included in the connection history information to the connection permission condition in FIG. 13 in the base stations B1, B2 and B3. FIG. 15 shows the connection permission condition set in the base stations A1, A2 and A3 and FIG. 16 shows the connection permission condition set in the base stations B1, B2 and B3.

Here, in FIG. 15 and FIG. 16, “Pass” indicates that connection is permitted when the condition is met and “Deny” indicates that connection is not permitted when the condition is met. When neither condition of “Pass” or “Deny” is met, connection is not permitted as in the cases of the above described examples. “Deny” exceptionally rejects connection for some of cases satisfying the condition of “Pass.” For example, both “Deny: Any→base station C (MAC address)→base station D (MAC address)” and “Deny: Any→base station C (MAC address)→base station D (MAC address)→Any” in FIG. 15 correspond to a subset of “Pass: Any→base station C (MAC address)→Any” but “Deny” exceptionally rejects connection in these cases. On the other hand, no connection permission condition is set in the base station C and the base station D. That is, suppose connection is unconditionally permitted to the base station C and the base station D.

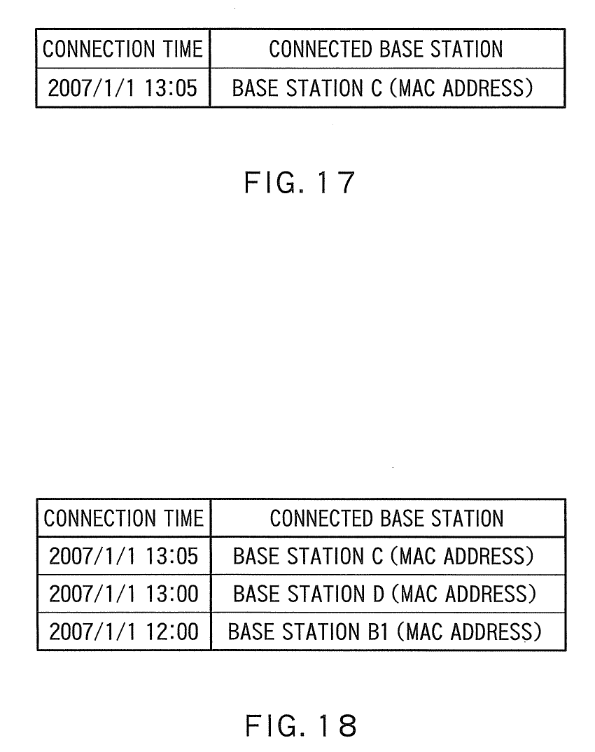

Assume a case where the mobile station H passes through the entrance A and directly enters the living room A. When passing through the entrance A, the mobile station H attempts to connect to the base station C. Upon receiving the connect request, the base station C acquires connection history information of the mobile station H from the connection history management server M, adds the base station C to the connection history information as the latest entry and uploads the connection history information after the addition to the connection history management server M. FIG. 17 shows an example of the connection history information of the mobile station H.

Next, the mobile station H enters the living room A. In this case, the connection history information of the mobile station H satisfies the connection permission conditions of the base stations A1, A2 and A3, but does not satisfy the connection permission conditions of the base stations B1, B2 and B3. Therefore, the mobile station H can reliably connect to only A1, A2 and A3 of good communication quality.

Assume a case where the mobile station H moves from the living room B to the living room A. The mobile station H attempts to connect to the base station D when passing through the entrance B. The base station D which has received the connect request acquires connection history information of the mobile station H from the connection history management server M, adds the base station D to the connection history information as the latest entry and uploads the connection history information after the addition to the connection history management server M. Next, the mobile station H attempts to connect to the base station C when passing through the entrance A. The base station C which has received the connect request acquires the connection history information of the mobile station H from the connection history management server M, adds the base station C to the connection history information as the latest entry and uploads the connection history information after the addition to the connection history management server M. FIG. 18 shows an example of the connection history information of the mobile station H in this case.

Next, the mobile station H enters the living room A. In this case, since the connection history information of the mobile station H satisfies the connection permission condition in FIG. 15, connection of the mobile station H to the base stations A1, A2 and A3 is permitted. On the other hand, though the connection history information of the mobile station H matches “Pass: Any→base station D (MAC address)→Any” in the connection permission condition in FIG. 16, connection of the mobile station H to the base stations B1, B2 and B3 is rejected because of the condition of “Deny: Any→base station D (MAC address)→base station C (MAC address).” Therefore, the mobile station H can reliably connect to only A1, A2 and A3 of good quality.

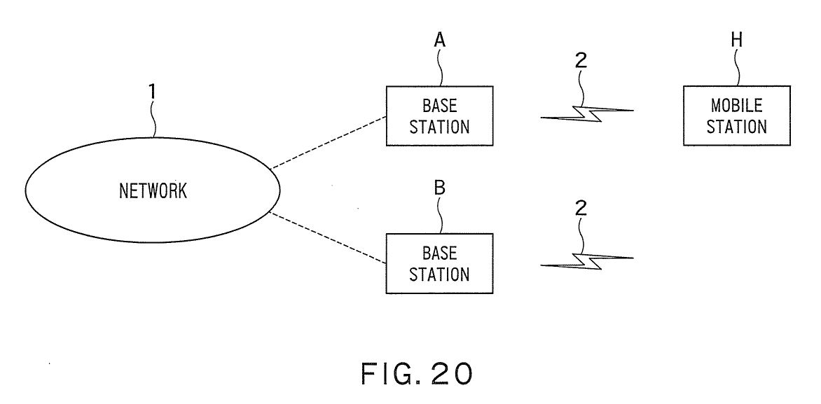

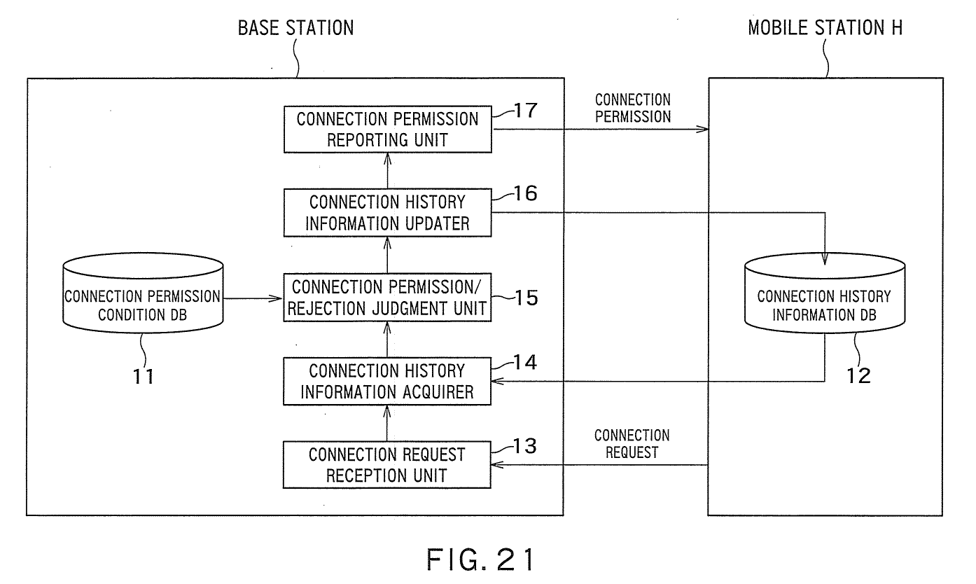

In this embodiment, the connection history management server M connected to the network 1 manages connection historys of the mobile station, but the mobile station itself can also manage the connection history information instead of installing the connection history management server M. FIG. 20 shows a configuration example of the communication system in this case. Furthermore, FIG. 21 shows a configuration example of the base station and the mobile station of the communication system in FIG. 20.

As shown in FIG. 21, the mobile station H is provided with an connection history information database 12 and the connection history information database 12 manages connection history information on connections to the base station in the past.

The connect request reception unit 13 of the base station receives a connect request from the mobile station H, the connection history information acquirer 14 acquires the connection history information of the mobile station H from the mobile station H which has issued the connection request from the connection history information database 12 of the mobile station H. When connection is permitted by connection permission/rejection judgment unit 15, connection history information updater 16 updates the connection history information by adding the base station to which connection is permitted and uploads the updated connection history information to connection history information database 12 of the mobile station H. That is, the base station B sends to the mobile station H an update request message for requesting an update of the connection history information so as to include the base station B as the latest connection destination.

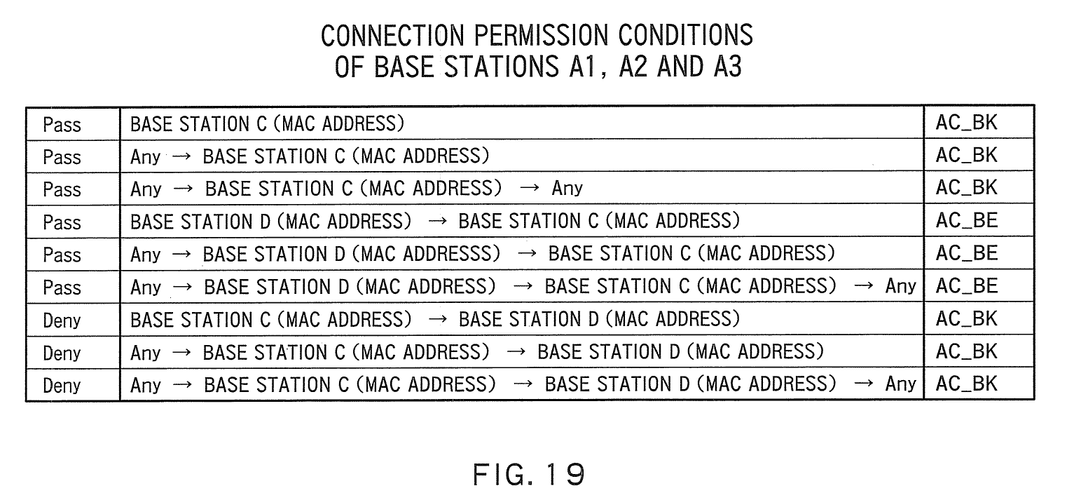

The embodiments of the present invention described so far are not limited to the above described contents, but can be modified and expanded in various ways. Some examples thereof will be shown hereunder.
(1) The base station may have a monitoring unit which performs life-and-death monitoring on base stations included in connection permission condition held by the base station. For example, it is possible to periodically send a request for ICMP (Internet Control Message Protocol) Echo, which is an Internet protocol and confirm the presence/absence of any response and thereby infer the operating situation of the base station. As a result, if the base station is not operating, an entry (i.e. condition) including the base station may be deleted from the connection permission conditions, and it is thereby possible to improve resistance to interference as the system. When, for example, the connection permission condition in FIG. 15 is set in the base station Al, if life-and-death monitoring detects that the base station D is not operating, the five entries (i.e. five conditions) including the base station D may be deleted.
(2) The mobile station may confirm whether or not connection to the handoff destination base station is possible beforehand before sending a connect request. For example, it is possible to independently perform messaging for confirmation using a sub-type reserved in an IEEE802.11 standard management frame. Knowing connectibility beforehand can avoid wasted attempts to connect to base stations to which connection is not permitted.
(3) The base station can not only judge the connectibility but also control priority of communication (traffic priority control) according to a matching entry (i.e. matching condition) in the connection permission condition. For example, access categories of the IEEE802.11e standard may be associated with entries (conditions) in the connection permission condition and a mobile station matching one condition may be classified under an access category corresponding to the one condition. FIG. 19 shows an example where access categories of the IEEE802.11e standard are further associated with the connection permission conditions in FIG. 15. “AC_BK” in the figure is an access category for background traffic and “AC_BE” is an access category for best effort data having higher priority than “AC_BK”. Therefore, in the floor configuration diagram in FIG. 14, a mobile station which has moved from the living room B to the living room A can carry out communication with higher priority than a mobile station which has moved directly to the living room A through the entrance A. The base station may also be provided with a traffic control unit that performs traffic priority control on the mobile station according to the priority (access category) set in the condition under which connection is permitted. As for association with priority, priority may be associated not only with the IEEE802.11e standard but also with the IEEE802.1p, DiffServ (Differentiated Services) on an IP network, ToS (Type of Service) or the like.

Instead of using an connection permission condition with which traffic control priority (e.g., access category) is associated to judge connection permission or rejection, it is also possible to use the connection permission condition only for traffic priority control. For example, it is possible to unconditionally permit connection to a mobile station and perform traffic priority control based on a connection permission condition associated with priority.

As described so far, the embodiment of the present invention performs connection control with a handoff destination based on histories of connections to a mobile station and a base station and thereby allows the mobile station to reliably connect to an appropriate base station while minimizing the introduction, operation or maintenance cost.

What is claimed is:

1. A wireless base station, which is one of a plurality of base stations each forming a wireless area and communicating with a mobile station within the wireless area, comprising:
a reception unit configured to receive an connection request from a mobile station that exists within the wireless area;
an information acquirer configured to acquire connection history information indicating connection history to a base station which was connected by the mobile station in the past;
a condition storage configured to store a connection permission condition to permit connection with the mobile station;
a judgment unit configured to judge whether or not the connection permission condition is satisfied based on the connection history information; and
a reporting unit configured to report a message of connection permission to the mobile station when the connection permission condition is satisfied.

2. The wireless base station according to claim 1, wherein the connection permission condition defines that a base station most recently connected by the mobile station is a specific base station.

3. The wireless base station according to claim 1, wherein the connection permission condition defines that the mobile station connected to a specific base station in the past.

4. The wireless base station according to claim 1, wherein the connection permission condition defines that the mobile station connected to specific base stations in predetermined order in the past.

5. The wireless base station according to claim 1, wherein the connection permission condition defines that the mobile station did not connect to a specific base station in the past.

6. The wireless base station according to claim 1, wherein the connection permission condition defines that the mobile station did not connect to specific base stations in predetermined order in the past.

7. The wireless base station according to claim 1, further comprising a monitoring unit configured to monitor life or death of a base station described in the connection permission condition,
wherein the connection permission condition includes a plurality of conditions,
the judgment unit judges whether or not at least one of the conditions is satisfied,
the reporting unit reports, when at least one of the conditions is satisfied, the message of connection permission to the mobile station, and
the monitoring unit deletes, when a non-operating base station is detected, a condition including the detected base station from the connection permission condition.

8. The wireless base station according to claim 1, wherein the reporting unit reports, when the connection permission condition is not satisfied, a message of connection rejection to the mobile station.

9. The wireless base station according to claim 1, further comprising a traffic priority control unit,
wherein the connection permission condition includes a plurality of conditions to each of which a different priority is set,
the judgment unit judges whether or not at least one of the conditions is satisfied,
the reporting unit reports, when at least one of the conditions is satisfied, the message of the connection permission to the mobile station, and
the traffic priority control unit executes traffic priority control on the mobile station according to the priority set to the satisfied condition.

10. The wireless base station according to claim 1, further comprising an information updater, wherein the information acquirer sends a message for requesting acquisition of the connection history information to a predetermined server via a network and thereby acquires the connection history information of the mobile station from the predetermined server, and
the information updater sends, when the connection permission condition is satisfied, an update request message for requesting an update of the connection history information so as to show that the wireless base station is a latest connected base station, to the predetermined server.

11. The wireless base station according to claim 1, further comprising an information updater,
wherein the information acquirer sends a message for requesting acquisition of the connection history information to the mobile station and thereby acquires the connection history information from the mobile station, and
the information updater sends, when the connection permission condition is satisfied, an update request message for requesting an update of the connection history information so as to show that the wireless base station is a latest connected base station, to the mobile station.

12. A communication method performed in a wireless base station which is one of a plurality of base stations each forming a wireless area and communicating with a mobile station within the wireless area, comprising:
receiving a connect request from a mobile station that exists within the wireless area;
acquiring connection history information indicating connection history to a base station which was connected by the mobile station in the past;
reading out a connection permission condition to permit connection with the mobile station from a condition storage storing the connection permission condition;
judging whether or not the connection permission condition is satisfied based on the connection history information; and
reporting a message of connection permission to the mobile station when the connection permission condition is satisfied.

13. A program storage medium storing a computer program for causing a wireless base station which is one of a plurality of base stations each forming a wireless area and communicating with a mobile station within the wireless area, to execute instructions to perform the steps of:
receiving a connect request from a mobile station that exists within the wireless area;
acquiring connection history information indicating connection history to a base station which was connected by the mobile station in the past;
reading out a connection permission condition to permit connection with the mobile station from a condition storage storing the connection permission condition;
judging whether or not the connection permission condition is satisfied based on the connection history information; and
reporting a message of connection permission to the mobile station when the connection permission condition is satisfied.
